(19) United States
(12) Patent Application Publication
(10) Pub. No.: US 2025/0016633 A1
(43) Pub. Date: Jan. 9, 2025

(54) 5G New Radio Mobility Enhancements

(71) Applicant: Apple Inc., CUPERTINO, CA (US)

(72) Inventors: Naveen Kumar R PALLE VENKATA, San Diego, CA (US); Alexander SIROTKIN, Hod Hasharon (IL); Fangli XU, Beijing (CN); Haijing HU, Los Gatos, CA (US); Pavan NUGGEHALLI, San Carlos, CA (US); Ralf ROSSBACH, Munich (DE); Sarma V VANGALA, Campbell, CA (US); Sethuraman GURUMOORTHY, San Ramon, CA (US); Yuqin CHEN, Beijing (CN); Zhibin WU, Los Altos, CA (US)

(21) Appl. No.: 18/710,694

(22) PCT Filed: Nov. 26, 2021
(86) PCT No.: PCT/CN2021/133474

§ 371 Date: May 16, 2024

(51) Int. Cl. H04W 36/00; H04W 72/231; H04W 76/30

(52) U.S. Cl. CPC H04W 36/00692; H04W 36/0016; H04W 72/231; H04W 76/30

(57) ABSTRACT

A user equipment (UE) is configured to activate a simultaneous communication functionality with a first cell and a second cell, wherein the first cell is configured as a serving cell and the second cell is configured as an assisting cell, determine that a serving cell switch is to be performed, wherein the serving cell switch comprises the second cell being reconfigured as the assisting cell and the first cell being reconfigured as the assisting cell, receive, after the serving cell switch, a message from the second cell indicating that the simultaneous communication functionality is to be deactivated and release the first cell in response to the message.

### TECHNICAL FIELD

This application relates generally to wireless communication, and in particular relates to 5G New Radio Mobility Enhancements.

### BACKGROUND

A user equipment (UE) may connect to a node of a network. Once connected, a handover of the UE may occur between a source node and a target node. In some scenarios, during the handover procedure, there may be a duration of time during which the UE is unable to transmit and/or receive data from the network. This mobility interruption time may have a negative impact on the user experience associated with the UE and/or the network.

A fifth generation (5G) new radio (NR) network may support layer 1 (L1)/layer 2 (L2) based mobility. Generally, L1/L2 based mobility refers to mechanisms that allow the network to change a serving cell of the UE. It has been identified that for 5G NR, there exists a need for a mobility framework that allows for L1/L2 based mobility and minimizes (or eliminates) mobility interruption time.

### SUMMARY

Some exemplary embodiments are related to a processor of a user equipment (UE) configured to perform operations. The operations include activating a simultaneous communication functionality with a first cell and a second cell, wherein the first cell is configured as a serving cell and the second cell is configured as an assisting cell, determining that a serving cell switch is to be performed, wherein the serving cell switch comprises the second cell being reconfigured as the assisting cell and the first cell being reconfigured as the assisting cell, receiving, after the serving cell switch, a message from the second cell indicating that the simultaneous communication functionality is to be deactivated and releasing the first cell in response to the message.

Other exemplary embodiments are related to a processor of a first base station configured to perform operations. The operations include transmitting configuration information to a user equipment (UE), wherein the configuration information configures the UE with a simultaneous communication functionality to a first cell configured as a serving cell and a second cell configured as an assisting cell and wherein the base station controls the first cell, receiving an indication from a second base station controlling the second cell that a serving cell switch is to be performed for the UE, wherein the serving cell switch comprises the second cell being reconfigured as the serving cell and the first cell being reconfigured as the assisting cell and receiving an indication from the second base station that the first cell is to be released by the UE.

Still further exemplary embodiments are related to a processor of a second base station configured to perform operations. The operations include transmitting a handover preparation acknowledgement to a first base station in response to a handover request associated with a user equipment (UE), wherein the first base station controls a first cell and the second base station controls a second cell and wherein the UE is to be configured with a simultaneous communication functionality to the first cell configured as a serving cell and the second cell configured as an assisting cell, transmitting an indication to the first base station that a serving cell switch is to be performed for the UE, wherein the serving cell switch comprises the second cell being reconfigured as the serving cell and the first cell switching being reconfigured as the assisting cell and transmitting a message to the UE indicating that the first cell is to be released by the UE.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a method for a fifth generation (5G) new radio (NR) handover according to various exemplary embodiments.

FIG. 5 shows a network arrangement according to various exemplary embodiments.

FIG. 6 shows a network arrangement according to various exemplary embodiments.

FIG. 7 shows a signaling diagram illustrating an example of the exemplary mobility framework.

FIG. 8 shows a signaling diagram illustrating an example of the exemplary mobility framework.

### DETAILED DESCRIPTION

The exemplary embodiments may be further understood with reference to the following description and the related appended drawings, wherein like elements are provided with the same reference numerals. The exemplary embodiments introduce enhancements for fifth generation (5G) new radio (NR) mobility. As will be described in more detail below, the exemplary embodiments provide a 5G NR mobility framework that allows for layer 1 (L1)/layer 2 (L2) based mobility and minimizes mobility interruption time.

The exemplary embodiments are described with regard to a user equipment (UE). However, reference to a UE is provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with regard to a handover of the UE between a source next generation node B (gNB) and a target gNB. Those skilled in the art will understand that the term “source gNB” generally refers to a gNB that is configured to trigger the handover of the UE. In some examples, the term “source gNB” may be used to refer to a gNB that is going to trigger a handover of the UE and/or to a gNB that has already triggered a handover of the UE, but the handover procedure has not yet been completed.

Those skilled in the art will understand that term “target gNB” generally refers to a gNB that is considered as a potential future serving node for the UE. For example, the source gNB may send a handover preparation request to another gNB. The request may be accepted or denied for any of a variety of different reasons (e.g., admission control, etc.). If the request is accepted, the network may be triggered to initiate a handover of the UE from a source gNB to this gNB in response to any of a variety of different conditions. In some examples, the term “target gNB” may be used to refer to a gNB that is going to receive a handover request from a source gNB and/or to a gNB that has already received the handover preparation request from the source gNB, but the handover procedure has not been completed. Once the handover is complete, the target gNB may then be characterized as a source gNB for the UE in a subsequent handover procedure.

A gNB may be configured with multiple transmission and reception points (TRPs). Throughout this description, a TRP generally refers to a set of components configured to transmit and/or receive a beam. In some embodiments, multiple TRPs may be deployed locally at the gNB. For example, the gNB may include multiple antenna arrays/panels that are each configured to generate a different beam. In other embodiments, multiple TRPs may be deployed at various different locations and connected to the gNB via a backhaul connection. For example, multiple small cells may be deployed at different locations and connected to the gNB. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

In addition, each gNB may support one or more cells. Throughout this description, the term “source cell” may refer to a cell operated by a source gNB. Similarly, the term “target cell” may refer to a cell operated by a target gNB. Since each gNB may support one or more cells, there may be a scenario in which multiple target cells are associated with the same target gNB. The UE may communicate with a cell over the air via a TRP. Due to the relationship between a TRP and a cell, the terms “TRP” and “cell” may be used interchangeably. For instance, in some examples, a “target cell” and a “target TRP” may be used interchangeably to generally refer to the same connection and/or node.

Further, reference may be made to a “serving cell” and a “neighbor cell.” Those skilled in the art will understand that a serving cell generally refers to a cell that is configured to transmit data to the UE. In some examples, the terms “source cell” and “serving cell” may be used interchangeably to refer to the same node. However, in some examples, the UE may be configured with multiple serving cells and each serving cell is not required to be a source cell.

Those skilled in the art will understand that a neighbor cell generally refers to a cell that is not a serving cell for the UE but located within the vicinity of the UE and/or a serving cell. In some examples, the terms “target cell” and “neighbor cell” may be used interchangeably to generally refer to the same node. However, a neighbor cell is not required to be a target cell.

The exemplary embodiments are also described with regard to L1/L2 based mobility. Those skilled in the art will understand that L1/L2 based mobility generally refers to a mechanism that allows the network to change a serving cell of the UE. For L1 based mobility, the serving cell may be changed by the network via L1 downlink control information (DCI). For L2 based mobility, the serving cell may be changed by the network via L2 medium access control (MAC) control element (CE) commands. In other examples, L1/L2 based mobility may utilize a combination of DCI, MAC CE and/or radio resource control (RRC) signaling. Thus, L1/L2 based mobility refers to two different procedures that rely on a similar concept but are distinguished from one another based on the manner in which the network triggers the UE transition from a serving cell to a target cell, e.g., DCI or MAC CE. Throughout this description, the term “L1/L2 based mobility” refers to either a L1 based mobility procedure or a L2 based mobility procedure.

The UE may perform measurements for L1/L2 based mobility on one or more neighbor cells using a specific downlink reference signal, e.g., a signal synchronization block (SSB) or a channel state information (CSI)-reference signal (RS), the measurements for L1/L2 based mobility may be based on SSB, CSI-RS or any other appropriate downlink resource. The measurement metric for L1/L2 based mobility may be L1-reference signal received power (RSRP), L1-signal interference-to-noise ratio (SINR), L1-reference signal received quality (RSRQ) or any other appropriate type of metric. However, any reference to L1/L2 based mobility utilizing a specific type of measurement, reference signal or metric is merely provided for illustrative purposes. The exemplary embodiments may apply to L1/L2 based mobility that utilizes any appropriate type of measurement, reference signal or metric.

The exemplary embodiments are also described with regard to a dual active protocol stack (DAPS) handover scheme. Those skilled in the art will understand that DAPS refers to a handover procedure where the source gNB connection is maintained after the handover command is received from the network and until the source cell is released after successfully connecting to the target gNB. During the DAPS handover, the UE may utilize multiple instances of one or more protocol stack layers to perform simultaneous reception of user data with a source cell and a target cell. For example, one protocol stack may be configured to communicate with the source cell and another protocol stack may be configured to communicate with the target cell. DAPS minimizes mobility interruption time during handover.

The exemplary embodiments introduce enhancements for 5G NR mobility. The exemplary enhancements provide a mobility framework that includes aspects of L1/L2 based mobility and characteristics of DAPS. Each of the exemplary enhancements described herein may be used independently from one another, in conjunction with currently implemented 5G NR mobility schemes, future implementations of 5G NR mobility schemes or independently from other 5G NR mobility schemes.

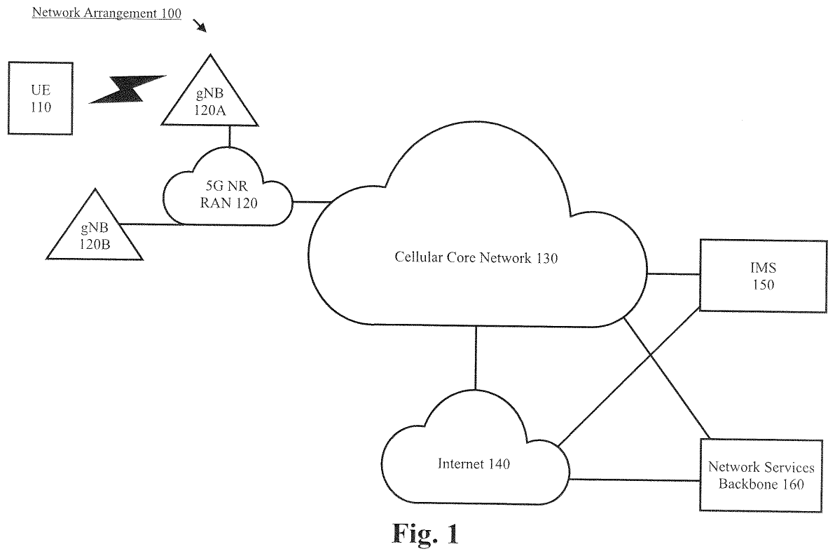

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

The 5G NR RAN 120 includes a gNB 120A and a gNB 120B. In this example, each of the gNBs 120A, 120B is configured with multiple TRPs. Each TRP may represent one or more components configured to transmit and/or receive a signal. In some embodiments, multiple TRPs may be deployed locally at a gNB. In other embodiments, multiple TRPs may be distributed at different locations and connected to the gNB via a backhaul connection. For example, multiple small cells may be deployed at different locations and connected to the gNB. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam. As indicated above, in some examples, the terms “TRP” and “cell” may be used interchangeably to generally refer to the same connection and/or node.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A, the gNB 120B.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

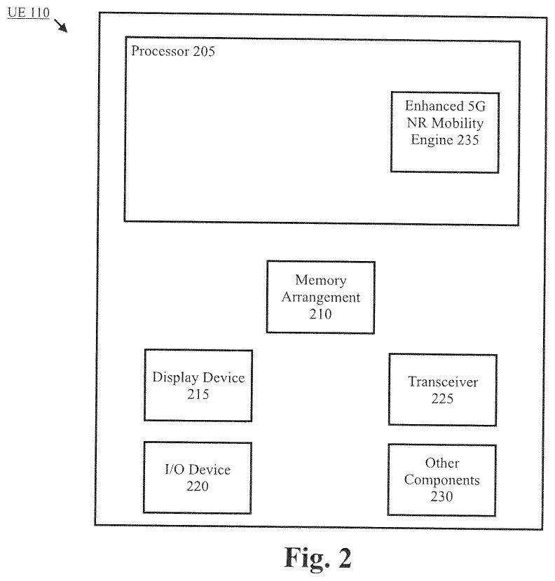

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include an enhanced 5G NR mobility engine 235. The enhanced 5G NR mobility engine 235 may perform various operations related to implementing the exemplary mobility framework described herein. These operations may include, but are not limited to, receiving configuration information, performing measurements, transmitting measurement reports, receiving DCI, receiving a MAC CE, etc.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

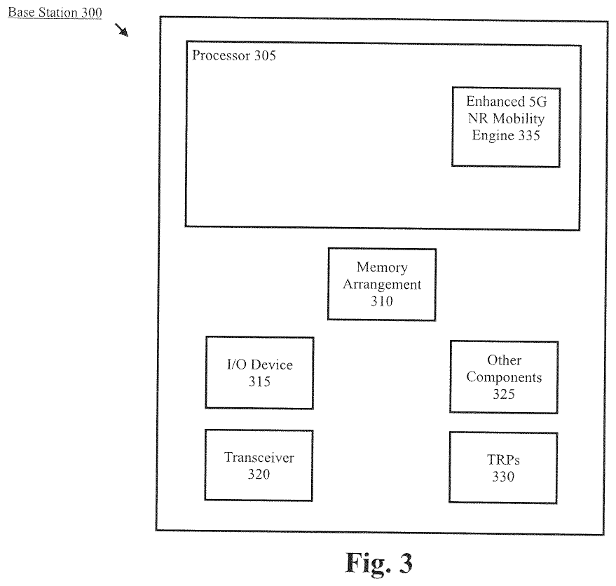

FIG. 3 shows an exemplary base station 300 according to various exemplary embodiments. The base station 300 may represent the gNB 120A, the gNB 120B or any other access node through which the UE 110 may establish a connection and manage network operations.

The base station 300 may include a processor 305, a memory arrangement 310, an input/output (I/O) device 315, a transceiver 320, other components 325 and multiple TRPs 330. As indicated above, in some scenarios, the multiple TRPs 330 may be deployed locally at the base station 300. In other scenarios, one or more of the multiple TRPs may be deployed at physical locations remote from the base station 300 and connected to the base statin via a backhaul connection. The base station 300 may be configured to control the multiple TRPs 330 and perform operations such as, but not limited to, assigning resources, configuring reference signals (or SSBs), implementing beam management techniques, etc.

The processor 305 may be configured to execute a plurality of engines for the base station 300. For example, the engines may include an enhanced 5G NR mobility engine 335. The enhanced 5G NR mobility engine 335 may perform various operations related to the exemplary mobility framework described herein. These operations may include, but are not limited to, transmitting a handover preparation request to another gNB, receiving capability information, transmitting configuration information, receiving measurement data, assigning resources, transmitting reference signals, transmitting DCI, transmitting a MAC CE, etc.

The above noted engine 335 being an application (e.g., a program) executed by the processor 305 is only exemplary. The functionality associated with the engine 335 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs. The other components 325 may include, for example, an audio input device, an audio output device, a battery, a data acquisition device, ports to electrically connect the base station 300 to other electronic devices, etc.

The exemplary embodiments are also described with regard to a logical architecture of a gNB which comprises a central unit (CU) and a distributed unit (DU). The term “gNB-CU” may refer to a logical node that is connected to the core network and one or more gNB-DUs. The term “gNB-DU” may refer to a logical node that is connected to a gNB-CU. To provide an example, each of the gNBs 120A, 120B may comprise a gNB-CU and one or more gNB-DUs. However, reference to the terms “gNB-CU” and “gNB-DU” is merely provided for illustrative purposes. Different entities may refer to similar concepts by a different name.

A gNB-CU may control its one or more gNB-DUs. Each gNB-DU may support one or more cells and/or one or more TRPs. Due to the relationship between these components, in some examples, the terms “gNB-DU,” “cell” and “TRP” may be used interchangeably to generally refer to the same connection and/or node. For instance, in some examples, a “target cell,” “target TRP” and “target qNB-DU” may be used interchangeably to generally refer to the same connection and/or node. Examples of gNB-CU and gNB-DU behavior within the context of the exemplary mobility framework is provided in detail below.

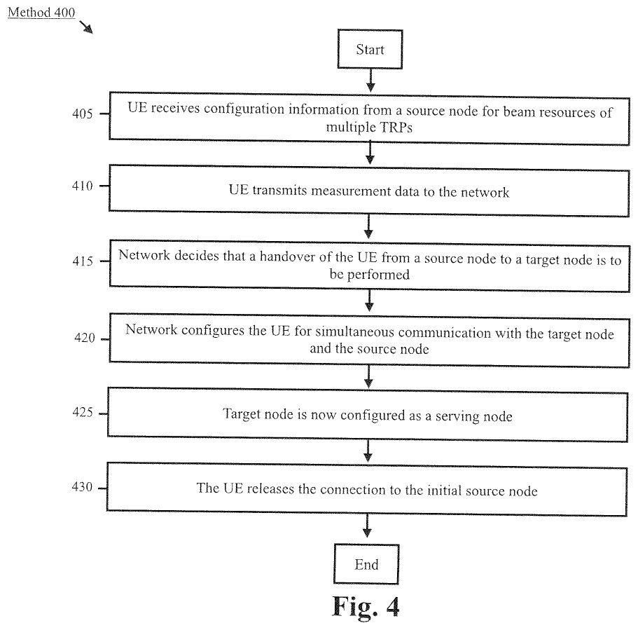

FIG. 4 shows a method 400 for a 5G NR handover according to various exemplary embodiments. The method 400 provides a general overview of the exemplary 5G NR mobility framework.

Initially, consider a scenario in which the UE 110 is connected to a 5G NR RAN 120 via the gNB 120A. Thus, the gNB 120A may be characterized as a source gNB for the UE 110. In this example, the source gNB may comprise a source gNB-CU, a source gNB-DU and a source TRP. As will be described in more detail below, the exemplary mobility framework described herein may account for an intra-CU mobility scenario where the UE 110 switches between cells, TRPs and/or gNB-DUs supported by the same gNB-CU. In addition, the exemplary mobility framework may account for an inter-CU mobility scenario where the UE 110 switches to a cell, TRP and/or gNB-DU controlled by a different gNB-CU.

In 405, the UE 110 receives configuration information from a source node about the beam resources of multiple TRPs. The TRPs may be associated with the same gNB-CU and gNB-DU, the same gNB-CU but different gNB-DU or from a different gNB-DU of a different gNB-CU. The configuration information may be provided to the UE 110 using one or more radio resource control (RRC) messages or in any other appropriate manner.

On the network side, for an inter-CU mobility scenario, the target gNB-CU may provide the relevant configuration information to the source gNB-CU which is then propagated to the source gNB-DU. For an intra-CU mobility scenario, there is not a target gNB-CU. The currently configured gNB-CU may already possess the relevant configuration information or may have to retrieve the configuration information from any appropriate source (e.g., a gNB-DU, a source remote from the gNB, etc.).

In 410, the UE 110 transmits measurement data to the network. In some examples, a measurement report may comprise layer 3 (L3) measurement data and provided to the network using RRC messages. Alternatively, or in addition to the L3 measurement data, the measurement report may comprise L2 and/or L1 measurement data. To provide a general example, the UE 110 may utilize a measurement gap or any other appropriate technique to receive and process reference signals from target cells. The UE 110 then may collect measurement data based on the reference signals.

In 415, the network may decide that a handover of the UE 110 from a source node to a target node is to be performed based on the measurement report and/or any other appropriate condition (e.g., network load, interference, providing access to particular network resources, etc.). However, the basis of this determination is beyond the scope of the exemplary embodiments.

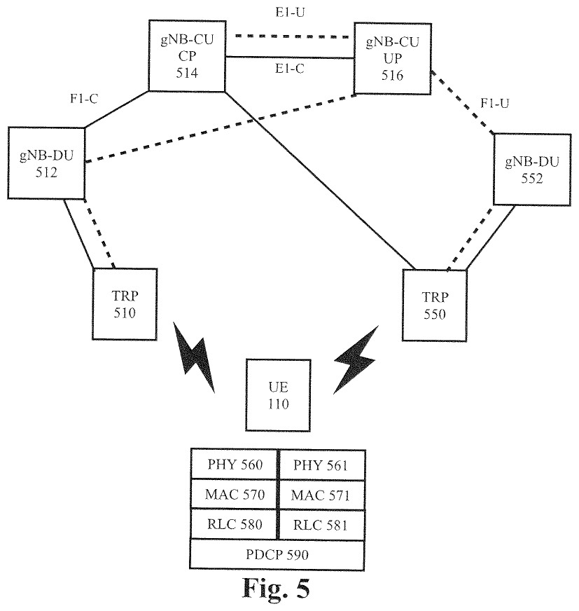

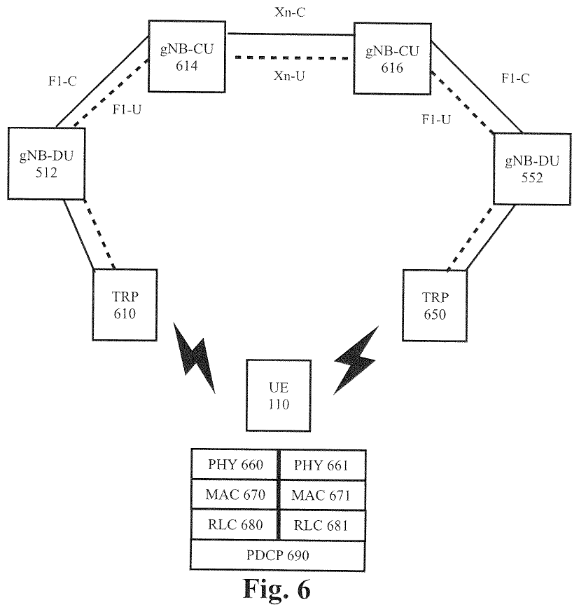

In 420, the network configures the UE 110 for simultaneous communication with the target node and the source node. As indicated above, the exemplary mobility framework described herein accounts for intra-CU mobility scenarios and inter-CU mobility scenarios. Accordingly, the network may configure the UE 110 to communicate with multiple nodes controlled to the same gNB-CU (e.g., intra-CU mobility) or multiple nodes each controlled by a different gNB-CU (e.g., inter-CU mobility). An example network arrangement for an intra-CU mobility scenario is provided below in FIG. 5 and an example network arrangement of an inter-CU mobility scenario is provided below in FIG. 6. Specific details regarding the signaling between network side components and the signaling between the UE 110 and the network to configure this functionality are provided below after the description of the network arrangements in FIGS. 5-6.

FIG. 5 shows a network arrangement 500 according to various exemplary embodiments. The following description will provide a general overview of the various components of the exemplary arrangement 500 within the context of an intra-CU mobility. The specific operations performed by the components with respect to the exemplary embodiments will be described in greater detail after the description of the network arrangement 500.

Those skilled in the art will understand that the components of the exemplary network arrangement 500 may reside in various physical and/or virtual locations relative to the network arrangement 100 of FIG. 1. These locations may include, within the access network (e.g., NR RAN 120), within the core network 130, within a gNB (e.g., gNB 120A and/or gNB 120B), as separate components outside of the locations described with respect to FIG. 1, etc.

In FIG. 5, the various components are shown as being connected via connections labeled F1-C, F1-U, E1-C and E1-U. The “U” designation may represent a user plane interface and the “C” designation may represent a control plane interface. Those skilled in the art will understand that each of these connections (or interfaces) are defined in third generation partnership program (3GPP) Specifications. The exemplary network arrangement 500 is using these connections in the manner in which they are defined in the 3GPP Specifications. However, these connections are provided for illustrative purposes and the exemplary embodiments may apply to any appropriate arrangement of components and interfaces. Furthermore, while these interfaces are termed connections throughout this description, it should be understood that these interfaces are not required to be direct wired or wireless connections, e.g., the interfaces may communicate via intervening hardware and/or software components. Thus, throughout this description the terms “connection” and “interface” may be used interchangeably to describe the interface between the various components.

The network arrangement 500 shows a scenario in which the UE 110 has already been configured to communicate with the target node and the source node simultaneously (e.g., 420 of the method 400). In this example, the UE 110 is configured to communicate with TRP 510 and TRP 550. In some embodiments, the TRPs 510, 550 may operate on different frequencies (e.g., inter-frequency mobility).

The TRP 510 is a serving TRP operated by gNB-DU 512 that is connected to a gNB-CU control plane (CP) node 514 and a gNB-CU user plane (UP) node 516. The TRP 550 is operated by a gNB-DU 552 that is also connected to the gNB-CU CP node 514 and the gNB-CU UP node 516. In this scenario, the TRP 550 may be characterized as a target TRP. In addition, the TRP 550 may be characterized as an “assisting TRP.” The term assisting TRP (or assisting cell) generally refers to a target TRP that may communicate with the UE 110 during a mobility procedure but the transition to the target node has not yet been completed. Once completed, the serving TRP and assisting TRP roles may switch, e.g., the TRP 510 may initially be configured as a serving TRP and then its role may be switched to an assisting TRP.

FIG. 5 also illustrates a portion of a protocol stack configuration that may be used by the UE 110 to simultaneously communicate with the TRP 510 and the TRP 550 during this intra-CU mobility scenario. In this example, the physical (PHY) layer is split into two instances. The PHY 560 may be used for communicating with the TRP 510 and the PHY 561 may be used for communicating with the TRP 550. The medium access control (MAC) layer may also be split into two instances. The MAC 570 may be used for communicating with the TRP 510 and the MAC 571 may be used for communicating with the TRP 550. The radio link control (RLC) layer may also be split into two instances. The RLC 580 may be used for communicating with the TRP 510 and the RLC 581 may be used for communicating with the TRP 550. There may be a common packet data convergence protocol (PDCP) layer 590 used to communicate with both the TRP 510 and the TRP 550. However, the exemplary embodiments are not limited to any particular type of protocol stack configuration. For instance, in an intra-CU mobility scenario, L1/L2 mobility may be performed with only the PHY split into multiple instances while the MAC, RLC and PDCP layers may be common to both connections. The exemplary embodiments may utilize any appropriate number of protocol stack layers split into multiple instances to enable simultaneous communication during the mobility procedure.

FIG. 6 shows a network arrangement 600 according to various exemplary embodiments. The following description will provide a general overview of the various components of the exemplary arrangement 600 within the context of an inter-CU mobility. The specific operations performed by the components with respect to the exemplary embodiments will be described in greater detail after the description of the network arrangement 600.

Those skilled in the art will understand that the components of the exemplary network arrangement 600 may reside in various physical and/or virtual locations relative to the network arrangement 100 of FIG. 1. These locations may include, within the access network (e.g., NR RAN 120), within the core network 130, within a gNB (e.g., gNB 120A and/or gNB 120B), as separate components outside of the locations described with respect to FIG. 1, etc.

In FIG. 6, the various components are shown as being connected via connections labeled F1-C, F1-U, Xn-C and Xn-U. The “U” designation may represent a user plane interface and the “C” designation may represent a control plane interface. Those skilled in the art will understand that each of these connections (or interfaces) are defined in 3GPP Specifications. The exemplary network arrangement 600 are using these connections in the manner in which they are defined in the 3GPP Specifications. However, these connections are provided for illustrative purposes and the exemplary embodiments may apply to any appropriate arrangement of components and interfaces. Furthermore, while these interfaces are termed connections throughout this description, it should be understood that these interfaces are not required to be direct wired or wireless connections, e.g., the interfaces may communicate via intervening hardware and/or software components.

The network arrangement 600 shows a scenario in which the UE 110 has already been configured to communicate with the target node and the source node simultaneously (e.g., 420 of the method 400). In this example, the UE 110 is configured to communicate with TRP 610 and TRP 650. In some embodiments, the TRPs 610, 650 may operate on different frequencies (e.g., inter-frequency mobility).

The TRP 610 is a serving TRP operated by gNB-DU 612 which is connected to a source gNB-CU 614. The TRP 650 is operated by a gNB-DU 652 which is connected to a target gNB-CU 616. The source gNB-CU 614 and the target gNB-CU 616 may communicate with one another using one or more interfaces (e.g., CP, UP, etc.).

In this scenario, the TRP 650 may be characterized as a target TRP. In addition, the TRP 650 may also be characterized as an assisting TRP. As indicated above, the term assisting TRP (or assisting cell) generally refers to a target TRP that may communicate with the UE 110 during a mobility procedure but the transition to the target node has not yet been completed. Once completed, the serving TRP and assisting TRP roles may switch, e.g., the TRP 610 may initially be configured as a serving TRP and then its role may be switched to an assisting TRP.

FIG. 6 also illustrates a portion of a protocol stack configuration that may be used by the UE 110 to simultaneously communicate with the TRP 610 and the TRP 650 during this intra-CU mobility scenario. In this example, the PHY layer is split into two instances. The PHY 660 may be used for communicating with the TRP 610 and the PHY 661 may be used for communicating with the TRP 650. The MAC) layer may also be split into two instances. The MAC 670 may be used for communicating with the TRP 610 and the MAC 671 may be used for communicating with the TRP 650. The RLC layer may also be split into two instances. The RLC 680 may be used for communicating with the TRP 610 and the RLC 681 may be used for communicating with the TRP 650. There may be a common PDCP layer used to communicate with both the TRP 610 and the TRP 650. However, the exemplary embodiments are not limited to any particular type of protocol stack configuration. The exemplary embodiments may utilize any appropriate number of protocol stack layers split into multiple instances to enable simultaneous communication during the mobility procedure.

Returning to 420 of the method 400, the network may configure the UE 110 to simultaneously communicate with a serving node and a target node (e.g., network arrangements 500-600). In 425, the target node is now configured as a serving node. For example, within the context of the network arrangement 500, a serving cell switch may occur and the TRP 550 may now be configured as a serving TRP and the TRP 510 may now be configured as an assisting TRP. In this intra-CU mobility scenario, there is no gNB-CU handover. To provide another example, within the context of the network arrangement 600, a serving cell switch may occur and the TRP 650 may now be configured as a serving TRP and the TRP 610 may now be configured as an assisting TRP. In this inter-CU mobility scenario, the roles of the gNB-CU 614 and the target gNB-CU 616 may change in conjunction with the serving cell switch or may not change until the connection to the initial source gNB-CU 614 is released.

In 430, the connection to the initial serving node (e.g., TRP 510, 610, etc.) and/or initial source node (e.g., gNB-CU 614) may be released. Additional details regarding the signaling and network side operations for this release is provided below with regard to the signaling diagrams 700-800.

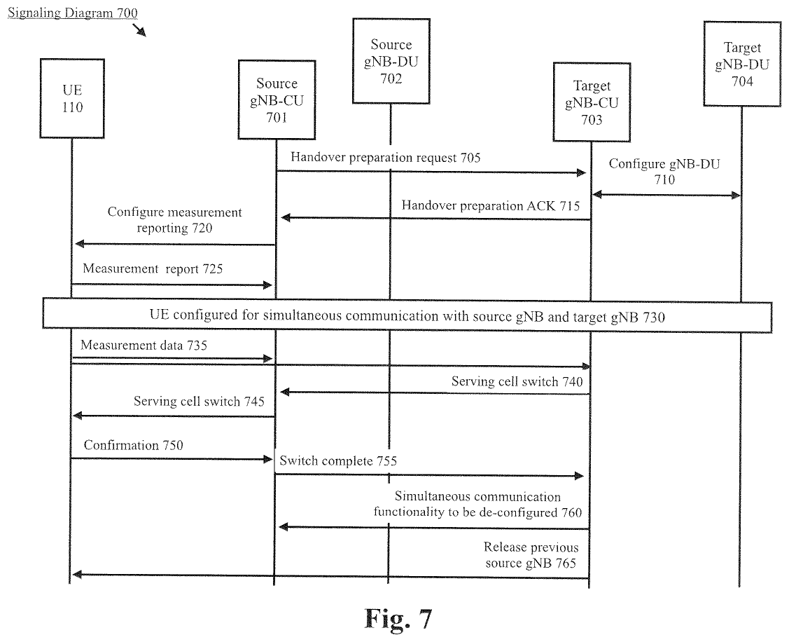

FIG. 7 shows a signaling diagram 700 illustrating an example of the exemplary mobility framework. The signaling diagram 700 includes the UE 110, a source gNB-CU 701, a source gNB-DU 702, a target gNB-CU 703 and a target gNB-DU 704. In this example, the UE 110 and the gNB-CUs 701, 703 are shown as communicating directly with one another. As indicated in the network arrangements 500, 600, in an actual deployment scenario, the signaling between the gNB-CUs and the UE 110 may be facilitated by gNB-DUs and TRPs. In addition, while the signaling diagram 700 illustrates an inter-CU mobility scenario, during the description of the signaling diagram 700 reference may be made to exemplary enhancements related to intra-CU mobility.

In 705, the source gNB-CU 701 transmits a handover preparation request to the target gNB-CU 703. For example, the gNB-CU 701 may communicate with the target gNB-CU 703 using an Xn interface. Here, it is assumed that the gNB-CU 703 accepts the request from the gNB-CU 701. However, in an actual deployment scenario, the gNB-CU 703 may reject the handover request for any of a variety of different reasons.

In 710, the target gNB-CU 703 configures the target gNB-DU 704 for the UE 110. This may include configuring and/or retrieving relevant reference signal configuration information (e.g., CSI-RS, etc.) from the gNB-DU 704. For example, the configuration information may include, but is not limited to, CSI-RS time domain information, CSI-RS frequency domain information, etc.

In 715, the target gNB-CU 703 transmits a handover preparation acknowledgement (ACK) to the source gNB-CU 701. The handover preparation ACK may be provided over the Xn interface and comprise the configuration information corresponding to the gNB-DU 704. In other embodiments, the configuration information may be provided to the source gNB-CU 701 in a message separate from the handover preparation ACK.

In 720, the UE 110 may configure the UE 110 to perform measurement reporting. For example, the source gNB may provide the UE 110 about the beam resources of multiple TRPs. The TRPs may be from the same gNB-CU and gNB-DU, the same gNB-CU but a different gNB-DU or from a different gNB-DU of a different qNB-CU. This information may enable the UE 110 to collect measurement data corresponding to multiple different TRPs.

In 725, the UE 110 provides a measurement report. To provide a general example, the UE 110 may be configured with a measurement gap (or configured to perform gap-less measurements) to collect measurement data on neighbor cells. In addition, the UE 110 may collect measurement data corresponding to its serving cell. The UE 110 may monitor the measurement data for the neighbor cells and the serving cells and if a predetermined condition occurs (e.g., measurement data exceeds threshold value, etc.), the UE 110 may be triggered to provide a measurement report. In some embodiments, the measurement report may comprise traditional L3 measurements. In other embodiments, alternatively or in addition to the L3 measurements, the UE 110 may report L1 and/or L2 measurement data. The network may utilize the measurement report to determine whether to perform a handover of the UE 110.

In 730, the network configures the UE 110 to simultaneously communicate with both a source node and a target node. The gNB-CU 701 may configure the UE 110 with this simultaneous communication functionality to minimize (or eliminate) mobility interruption time. The network may configure the UE 110 with this functionality using one or more RRC messages or any other appropriate type of signaling. Although not shown in the signaling diagram 700, in an actual deployment scenario, the over the air communication between the UE 110 and the gNB-CUs may be facilitated by the gNB-DUs.

To provide an example of how the network may configure this functionality, the source gNB-CU 701 may decide to handover the UE 110 to another node. On the network side, the source gNB-CU 701 and the target gNB-CU 702 may set up the data path (e.g., UP configuration) and the source gNB-CU 701 may acquire a security key configuration that the target gNB-CU 703 intends to utilize. The source gNB-CU 701 may then configure the UE 110 to enter an operating mode where one or more protocol stack layers are split into multiple instances (e.g., DAPS, the protocol stacks shown in FIGS. 6-7, etc.). The source gNB-CU 701 may then provide the UE 110 with the relevant security configuration information and/or additional RRC configuration information to enable the simultaneous communication functionality. In an intra-CU mobility scenario, the source gNB may configure the UE 110 with multi-TRP operation where the UE 110 is configured to transmit and/or receives on both a source TRP and a target TRP.

In 735, the UE 110 reports measurement data to the source gNB-CU 701 and/or the target qNB-CU 703. This measurement data may comprise one or more of L2 measurement data, L1 measurement data and L3 measurement data. This measurement data may trigger a serving cell switch. In some embodiments, this report may be provided using L1 uplink control information (UCI) on a physical uplink control channel (PUCCH) or a physical uplink shared channel (PUSCH). However, the exemplary embodiments are not limited to L1 UCI and may report this data using any appropriate L1, L2 or L3 signal.

As indicated above, while the UE 110 is configured to communicate simultaneously communicate with more than one TRP, the UE 110 may be configured to measure and report the measurements of the TRP reference signals (e.g., the UE 110 dedicated reference signals which may be different than the reference signals used to collect measurement data used in 720.). This report may comprise L3 measurement data, L2 measurement data and/or L1 measurement data. In some embodiments, this measurement report may be provided using L1 uplink control information (UCI) on a physical uplink control channel (PUCCH) or physical uplink shared channel (PUSCH).

In an intra-CU mobility scenario, the L3 or L2 measurements may be sent on either or both beams by the UE 110. The network may indicate to the UE 110 which beam to use for reporting, or the UE 110 may decide which beam to use based on any appropriate condition. In an inter-CU mobility scenario, L2 measurement may be sent on either or both beams by the UE 110. The network may indicate to the UE 110 which beam to use for reporting, or the UE 110 may decide which beam to use based on any appropriate condition. In FIG. 7, the reporting is shown as being performed on both beams.

The network may indicate to the UE 110 the reference signals to be measured and their corresponding IDs. The UE 110 may use the ID in the measurement report to indicate to the network which beam and/or reference signal is being measured. For example, the measurement report may include a TRP ID, a reference signal ID and a corresponding measurement data. In some embodiments, the measurement data may be an absolute measurement value. In other embodiments, a quantized look-up table may be utilized where each enumerated item reflects a particular value or range. The look up table may be hard encoded in the 3GPP standard or predefined for the UE 110 and the network in any other appropriate manner.

In 740, the target gNB-CU 703 triggers a soft handover of the UE 110. For example, the target gNB-CU 703 may send a message to the source gNB-CU 701 indicating that a serving cell switch is to be performed. As indicated above with regard to the network arrangements 600-700, a serving cell switch may refer to a change in the serving cell and assisting cell roles.

In 745, the source qNB-CU 701 transmits a serving cell switch indication to the UE 110. This indication may be provided via L1 DCI, L2 MAC CE or L3 RRC signaling. From the perspective of the UE 110, the serving cell switch may comprise the UE 110 updating its primary serving cell (e.g., primary cell (PCell), primary secondary cell (PSCell), anchor cell, etc.) to the target TRP. In 750, the UE 110 serving cell switch confirmation to the source gNB-CU 701. In 755, the gNB-CU 701 may transmit a serving cell switch complete message to the qNB-CU 703. At this time, although the serving cell has been switched, the UE 110 may still communicate with the TRP of the gNB-CU 701 and the TRP of the gNB-CU 703. However, the role of the TRP for the gNB-CU 701 may switch from serving to assisting and the role of the TRP for the gNB-CU 703 may switch from assisting to serving.

In 760, the new source gNB-CU 703 initiates the removal of the previous source gNB-CU 701. For example, the gNB-CU 703 may inform the gNB-CU 701 via the Xn interface that the UE 110 simultaneous communication functionality is to be de-configured or deactivated. In 765, the new source gNB-CU 703 may transmit a message to the UE 110 triggering the UE 110 to release the previous source gNB-CU 701 configuration and/or deactivate the simultaneous communication functionality. This message may be an RRC message or any other appropriate type of signaling. In some embodiments, prior to initiating the removal of the previous source node, the network may decide that the new serving cell is no longer appropriate and switch back to the previous serving cell (e.g., gNB-CU 701).

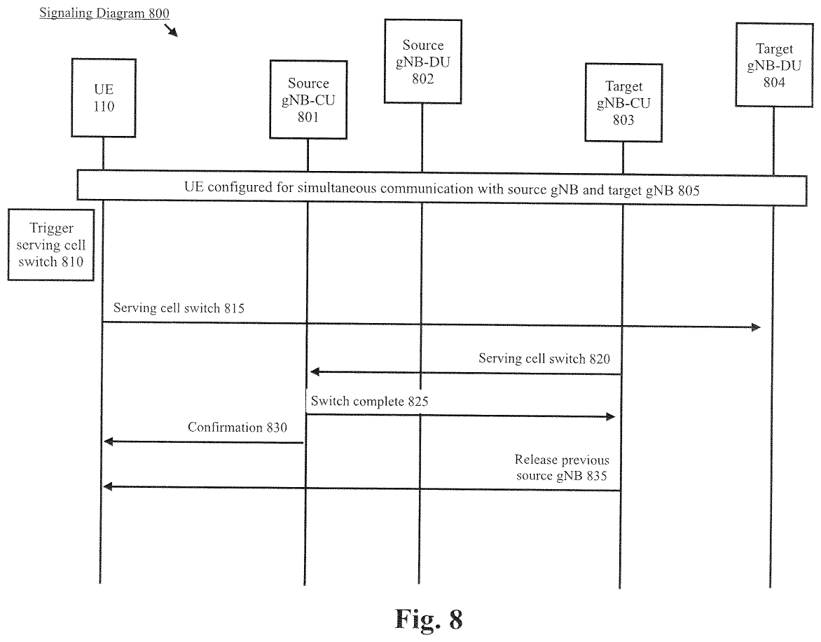

FIG. 8 shows a signaling diagram 800 illustrating an example of the exemplary mobility framework. The signaling diagram 800 includes the UE 110, a source gNB-CU 801, a source gNB-DU 802, a target gNB-CU 803 and a target gNB-DU 804. In this example, the UE 110 and the gNB-CUs 801, 803 are shown as communicating directly with one another. As indicated in the network arrangements 500, 600, in an actual deployment scenario, the signaling between the gNB-CUs and the UE 110 may be facilitated by gNB-DUs and TRPs. In addition, while the signaling diagram 800 illustrates an inter-CU mobility scenario, during the description of the signaling diagram 800 reference may be made to exemplary enhancements related to intra-CU mobility.

In 805, the network configures the UE 110 to simultaneously communicate with both a source node and a target node. This is similar to 730 of the signaling diagram 700. In this example, it is assumed that operations 705-725 or any other appropriate type of signaling has already been performed to enable this functionality at the UE 110.

The gNB-CU 801 may configure the UE 110 with this simultaneous communication functionality to minimize (or eliminate) mobility interruption time. The network may configure the UE 110 with this functionality using one or more RRC messages or any other appropriate type of signaling. Although not shown in the signaling diagram 800, in an actual deployment scenario, the over the air communication between the UE 110 and the gNB-CUs may be facilitated by the gNB-DUs.

In 810, the UE 110 triggers a serving cell switch. This is in contrast to the signaling diagram 700 where the UE 110 transmits measurement data in 735. In the signaling diagram 800, the UE 110 informs the network that the UE 110 has switched its serving cell. Thus, the UE 110 may update its primary serving cell without receiving an explicit command from the network. The UE 110 may information the network of this switch using an explicit RRC message (L3), a MAC CE (L2) or UCI (L1). In some embodiments, the network may configure the UE 110 to initiate this serving cell switch and if the network does not explicitly configure this functionality the UE 110 may not trigger the serving cell switch.

Briefly returning to the signaling diagram 700, in 735, alternatively or in addition to reporting measurement data, the UE 110 may transmit a request for a serving cell switch. This request may be transmitted as a L1, L2 or L3 signal. The remaining signaling in the signaling diagram 700 may remain the same. Thus, in contrast to transmitting measurement data and letting the network initiate the serving cell switch, the UE 110 may request a serving cell switch or as shown in the signaling diagram 800, the UE 110 may trigger the serving cell switch and then inform the network of the switch.

The criteria for the UE 110 to perform the UE triggered serving cell switch (e.g., 810) or explicitly request a serving cell switch from the network as described in the example above may be the similar. Examples of this criteria are provided below and described with regard to the signaling diagram 800. However, those skilled in the art will understand how the criteria may be used to trigger the UE 110 to request a serving cell switch in addition to or instead of providing measurement data in 735 of the signaling diagram 700.

The criteria may be configured by the network in any appropriate manner. For example, the network may provide the UE 110 with a set of conditions and if the conditions are satisfied, the UE 110 requests or triggers the serving cell switch. One condition may relate to a signal strength metric of a beam corresponding to a target cell being greater than a threshold value or higher than a threshold relative to the current serving cell. Another condition may relate to a signal strength metric of a beam corresponding to a serving cell being lower than a threshold value or lower than a threshold relative to the potential target serving cell. However, the exemplary embodiments are not limited to any particular condition and may utilize a combination of the example conditions provided above or any other appropriate set of one or more conditions.

In 815, the UE 110 transmits a serving cell switch indication to the target gNB-CU 803 indicating that the UE 110 has performed the UE triggered serving cell switch. In 820, the target gNB-CU 803 transmits a serving cell switch indication to the source gNB-CU 801. In 825, the gNB-CU 801 transmits a serving cell switch complete message to the gNB-CU 803. In 830, the gNB-CU 801 transmits a serving cell switch confirmation indication to the UE 110. This indication may be provided using L1 signaling, L2 signaling or L3 signaling.

In 835, the new source gNB-CU 803 may transmit a message to the UE 110 triggering the UE 110 to release the previous source gNB-CU 801 configuration. This message may be an RRC message or any other appropriate type of signaling. In some embodiments, prior to initiating the removal of the previous source node, the UE 110 or the network may decide that the new serving cell is no longer appropriate and switch back to the previous serving cell (e.g., gNB-CU 801).

The exemplary enhancements described herein may be extended to a scenario in which the target gNB-DU is one target cell from a pool of target cells. The UE 110 may be configured with multiple TRP configurations across different frequencies. A cell switch in this scenario may be triggered when the UE 110 is provided with DCI or a MAC CE indicating that physical downlink control channel (PDCCH) reception on an assisting cell is to occur.

The examples provided above were described with regard to a single serving cell. Those skilled in the art will understand that the exemplary enhancements described herein may also be applicable to carrier aggregation (CA), dual connectivity (DC) and/or cell groups (e.g., primary cell group (PCG), secondary cell group (SCG)). For example, the signaling diagrams 700-800 may be performed for one of the PCG or the SCG.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a user equipment (UE) configured to perform operations comprising:
activating a simultaneous communication functionality with a first cell and a second cell, wherein the first cell is configured as a serving cell and the second cell is configured as an assisting cell;
determining that a serving cell switch is to be performed, wherein the serving cell switch comprises the second cell being reconfigured as the assisting cell and the first cell being reconfigured as the assisting cell;
receiving, after the serving cell switch, a message from the second cell indicating that the simultaneous communication functionality is to be deactivated; and
releasing the first cell in response to the message.

2. The processor of claim 1, the operations further comprising:
receiving a signal from the network indicating that the serving cell switch is to be performed, wherein the signal is one of a downlink control information (DCI), a medium access control (MAC) control element (CE) or a radio resource control (RRC) message.

3. The processor of claim 1, wherein, prior to the serving cell switch, the serving cell is one of a primary cell (PCell) or a primary secondary cell (PSCell) and the assisting cell is a target cell and wherein the serving cell switch comprises updating the one of the PCell or the PSCell to the target cell while maintaining the simultaneous communication functionality with the one of the PCell or the PSCell and the target cell.

4. The processor of claim 1, the operations further comprising:
receiving, after the serving cell switch and prior to receiving the message from the second cell indicating that the simultaneous communication functionality is to be deactivated, a command from the network for a second serving cell switch wherein the second serving cell switch comprises the second cell being reconfigured as the assisting cell and the first cell being reconfigured as the serving cell.

5. The processor of claim 1, the operations further comprising:
receiving configuration information corresponding to multiple transmission reception points (TRPs).

6. The processor of or claim 1, the operations further comprising:
receiving, prior to activating the simultaneous communication functionality with the first cell and the second cell, a security key for the second cell.

7. The processor of claim 1, the operations further comprising:
reporting, while the simultaneous communication functionality is configured, measurement data to the network wherein the measurement data corresponds to a transmission reception point (TRP) of the second cell.

8. The processor of claim 7, wherein the report uses layer 2 (L2) measurements, layer 3 (L3) measurements or layer 1 (L1) uplink control information (UCI).

9. The processor of claim 7, wherein the measurement data is transmitted to both the first cell and the second cell.

10. The processor of claim 7, wherein the measurement data comprises a transmission reception point (TRP) ID, a reference signal ID and a corresponding measurement value.

11. The processor of claim 1, wherein determining that the serving cell switch is to be performed comprises identifying that measurement data corresponding to one of the first cell or the second cell satisfies a predetermined condition.

12. The processor of claim 1, the operations further comprising:
transmitting an indication to the second cell that the UE has updated its serving cell to the second cell.

13. The processor of claim 1, the operations further comprising:
transmitting a request for the serving cell switch to one of the first cell or the second cell.

14. (canceled)

15. A processor of a first base station configured to perform operations comprising:
transmitting configuration information to a user equipment (UE), wherein the configuration information configures the UE with a simultaneous communication functionality to a first cell configured as a serving cell and a second cell configured as an assisting cell and wherein the base station controls the first cell;
receiving an indication from a second base station controlling the second cell that a serving cell switch is to be performed for the UE, wherein the serving cell switch comprises the second cell being reconfigured as the serving cell and the first cell being reconfigured as the assisting cell; and
receiving an indication from the second base station that the first cell is to be released by the UE.

16. The processor of claim 15, the operations further comprising:
transmitting a signal to the UE indicating that the serving cell switch is to be performed, wherein the signal is one of a downlink control information (DCI), a medium access control (MAC) control element (CE) or a radio resource control (RRC) message.

17. The processor of claim 15, the operations further comprising:
transmitting a message to the UE indicating beam resources for multiple transmission reception points (TRPs), wherein the multiple TRPs are associated with a same next base station or a different base station.

18. The processor of claim 15, wherein the configuration information comprises a security key corresponding to the second cell.

19. The processor of claim 18, the operations further comprising:
receiving, prior to transmitting the configuration information, the security key from a second base station that controls the second cell.

20. The processor of claim 15, the operations further comprising:
configuring a data path of a user plane configuration with a second base station that controls the second cell.

21. (canceled)

22. A processor of a second base station configured to perform operations comprising:
transmitting a handover preparation acknowledgement to a first base station in response to a handover request associated with a user equipment (UE), wherein the first base station controls a first cell and the second base station controls a second cell and wherein the UE is to be configured with a simultaneous communication functionality to the first cell configured as a serving cell and the second cell configured as an assisting cell;
transmitting an indication to the first base station that a serving cell switch is to be performed for the UE, wherein the serving cell switch comprises the second cell being reconfigured as the serving cell and the first cell switching being reconfigured as the assisting cell; and
transmitting a message to the UE indicating that the first cell is to be released by the UE.

23-27. (canceled)
